(19) United States
(12) Patent Application Publication
(10) Pub. No.: US 2007/0211392 A1
(43) Pub. Date: Sep. 13, 2007

(54) Spin valve with Ir-Mn-Cr pinning layer and seed layer including Pt-Mn

(76) Inventor: Alexander M. Zeltser, San Jose, CA (US)

Correspondence Address: ROGITZ & ASSOCIATES, 750 B STREET, SUITE 3120, SAN DIEGO, CA, 92101, US

(21) Appl. No.: 11/370,773

(22) Filed: Mar. 8, 2006

(51) Int. Cl. G11B 5/33; G11B 5/127

(52) U.S. Cl. 360/324.11

(57) ABSTRACT

In a disk drive GMR or TMR head that uses Ir—Mn—Cr as a pinning layer, Pt—Mn is used as part of the seed layer below the pinning layer to enhance GMR and pinning without deleteriously affecting other head characteristics and to improve head thermal stability.

### I. FIELD OF THE INVENTION

The present invention relates in general to magnetoresistive devices, and more particularly to magnetoresistive devices that use exchange-coupled antiferromagnetic/ferromagnetic (AF/F) structures, such as current-in-the-plane (CIP) read heads and current-perpendicular-to-the-plane (CPP) magnetic tunnel junctions and read heads.

### II. BACKGROUND OF THE INVENTION

In magnetic disk drives, data is written and read by magnetic transducers called “heads.” The magnetic disks are rotated at high speeds, producing a thin layer of air called an air bearing (AB). The read and write heads are supported over the rotating disk by an air bearing surface (ABS), where they either induce or detect flux on the magnetic disk, thereby either writing or reading data. Layered thin film structures are typically used in the manufacture of read and write heads. In write heads, thin film structures provide high magnetic flux to produce recorded magnetic bits on a recording disk with high areal density, which is the amount of data stored per unit of disk surface area, and in read heads they provide high resolution.

Some read heads in magnetic disk drives use so-called current-in-plane (CIP) magnetoresistive principles, a common example of which is a device that uses an exchange-coupled structure and that is known as a spin-valve (SV) type of giant magnetoresistive (GMR) sensor. The SV GMR head has two ferromagnetic layers separated by a very thin nonmagnetic conductive spacer layer, typically copper, wherein the electrical resistivity for the sensing current in the plane of the layers depends upon the relative orientation of the magnetizations in the two ferromagnetic layers. The direction of magnetization or magnetic moment of one of the ferromagnetic layers (the “free” layer or stack) is free to rotate in the presence of the magnetic fields from the recorded data, while the other ferromagnetic layer (the “fixed” or “pinned” layer or stack) has its magnetization fixed by being exchange-coupled with an adjacent antiferromagnetic layer. The pinned ferromagnetic layer and the adjacent antiferromagnetic layer form an exchange-coupled structure.

Another type of magnetoresistive device that may be used to establish a read head is a current-perpendicular-to-the-plane (CPP) spin valve GMR sensor. The CPP spin valve read head is structurally similar to the widely used CIP spin valve read head, with the primary difference being that the sense current is directed perpendicularly through the interfaces between the two ferromagnetic layers and the nonmagnetic spacer layer.

In either case, within the scope of the present invention, it is understood that it is desirable to increase the amount of giant magnetoresistance (GMR) in spin valves, particularly those that use Ir—Mn or Ir—Mn—Cr as the pinning layer, without deleterious side effects such as degraded magnetic pinning or decreased magnetic softness of the free layer. With these recognitions in mind, the invention herein is provided.

### SUMMARY OF THE INVENTION

The invention may be applied to bottom single and dual current in plane and current perpendicular to plane GMR sensors and bottom single and dual TMR sensors.

A magnetoresistive sensor structure has a magnetically pinned stack and a pinning layer including Ir—Mn (preferably, Ir—Mn—Cr) that serves to magnetically pin the pinned stack. A seed stack that includes a thin layer of Pt—Mn is provided.

In one non-limiting implementation the seed stack includes a Ni—Fe—Cr layer covered by a Ni—Fe layer, and in this embodiment the layer of Pt—Mn covers the Ni—Fe layer. In another non-limiting implementation the layer of Pt—Mn is covered by a Ni—Fe—Cr layer that in turn is covered by a Ni—Fe layer. The layer of Pt—Mn can be between one and ten Angstroms thick and preferably is five Angstroms thick, which is significantly thinner than its critical thickness of about 90 Angstroms, above which Pt—Mn can be transformed upon annealing from FCC paramagnetic phase to L1₀ ordered antiferromagnetic phase and can itself act as a pinning layer.

In another aspect, a method for making a magnetoresistive sensor structure includes forming a seed stack including at least one layer of Pt—Mn, and depositing onto the seed stack an antiferromagnetic layer that includes Ir—Mn—Cr. The antiferromagnetic layer may be deposited onto a sufficiently preheated seed stack to promote relatively large grain size and/or ordering of Ir—Mn—Cr from disordered antiferromagnetic FCC phase to ordered antiferromagnetic L1₂ phase, which enhances pinning.

In still another aspect, a magnetic recording sensor includes a free stack, a pinned stack, and a barrier between the free stack and pinned stack. An Ir—Mn—Cr layer provides magnetic pinning for the pinned stack, and a seed stack underlies the Ir—Mn—Cr layer. The seed stack includes means for promoting grain growth and interfacial smoothness in the Ir—Mn—Cr layer.

In another aspect, a magnetic storage device includes a spindle rotating a magnetic recording disk and a slider juxtaposed with the disk. The slider has at least one magnetic head and is supported by a suspension coupled to an actuator arm, the arm in turn being rotatably positioned by an actuator. The head includes a magnetically pinned stack, a pinning layer including Ir—Mn and magnetically pinning the pinned stack, and a seed stack comprising a layer of Pt—Mn.

In another aspect, a magnetoresistive sensor includes a free stack, a pinned stack, and a barrier between the free stack and pinned stack. An Ir—Mn—Cr layer provides magnetic pinning for the pinned stack, and a seed stack underlies the Ir—Mn—Cr layer. The seed stack includes means for promoting grain growth and interfacial smoothness in the Ir—Mn—Cr layer.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a schematic plan view of a hard disk drive, showing one non-limiting environment for the present invention;

FIG. 2 is an elevational view of a first embodiment of a non-limiting device made in accordance with the present invention;

FIG. 3 is an elevational view of a second embodiment of a non-limiting device made in accordance with the present invention; and

FIGS. 4-7 are graphs showing various characteristics of non-limiting devices made in accordance with present principles, with the various characteristics plotted as the ordinate versus Pt—Mn layer thickness as the abscissa.

### DETAILED DESCRIPTION OF THE PREFERRED EMBODIMENT

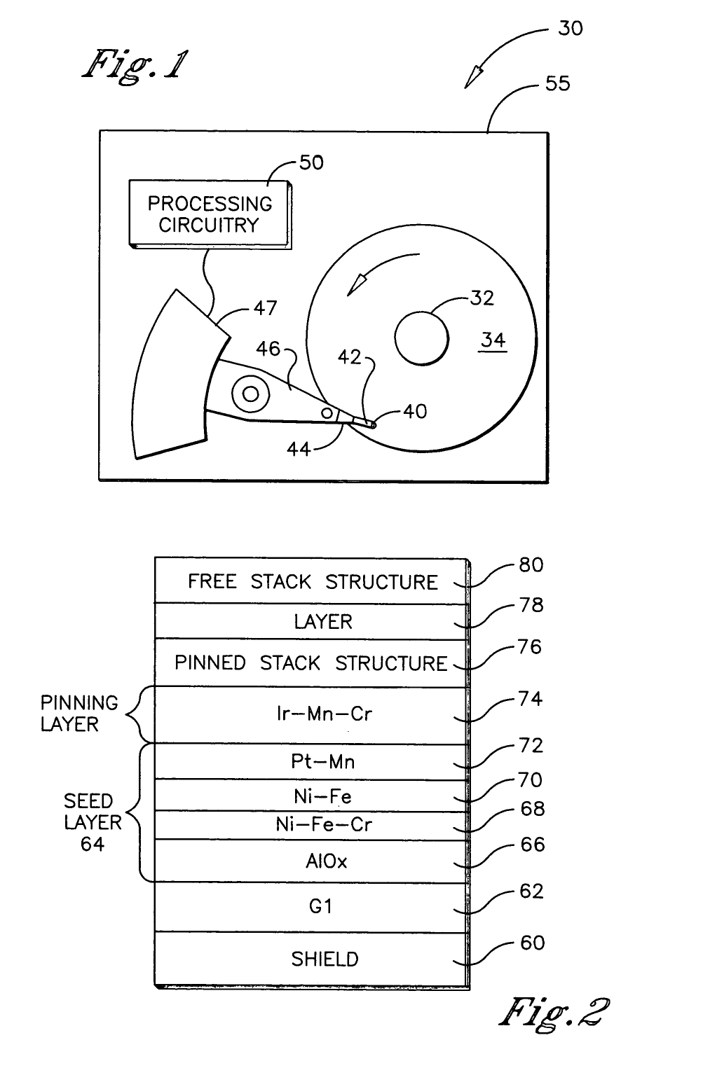

Referring initially to FIG. 1, a magnetic disk drive 30 includes a spindle 32 that supports and rotates a magnetic disk 34. The spindle 32 is rotated by a spindle motor that is controlled by a motor controller which may be implemented in the electronics of the drive. A slider 42 has a combined read and write magnetic head 40 and is supported by a suspension 44 and actuator arm 46 that is rotatably positioned by an actuator 47. The head 40 may be a GMR or MR head or other magnetoresistive head. It is to be understood that a plurality of disks, sliders and suspensions may be employed. The suspension 44 and actuator arm 46 are moved by the actuator 47 to position the slider 42 so that the magnetic head 40 is in a transducing relationship with a surface of the magnetic disk 34. When the disk 34 is rotated by the spindle motor 36 the slider is supported on a thin cushion of air known as the air bearing that exists between the surface of the disk 34 and an air bearing surface (ABS) of the head. The magnetic head 40 may then be employed for writing information to multiple circular tracks on the surface of the disk 34, as well as for reading information therefrom. To this end, processing circuitry 50 exchanges signals, representing such information, with the head 40, provides spindle motor drive signals for rotating the magnetic disk 34, and provides control signals to the actuator for moving the slider to various tracks. The components described above may be mounted on a housing 55.

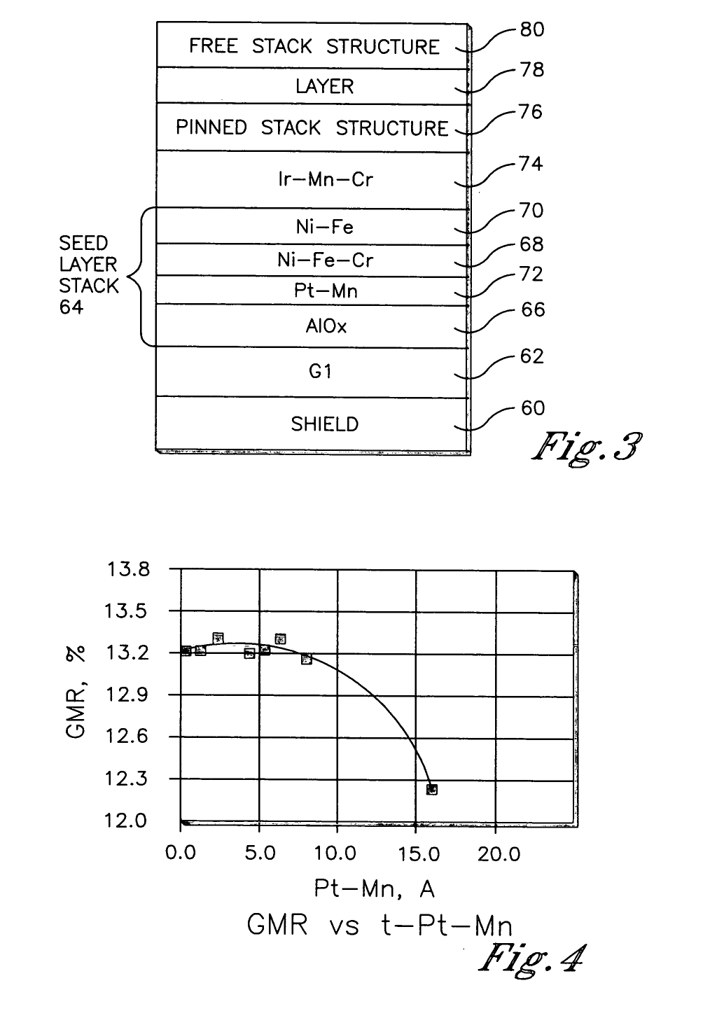

Now referring to FIG. 2, the head 40 which is manufactured using the process of the present invention includes a lower magnetic shield 60 that may be made of, e.g., Ni—Fe or other suitable material. On top of the lower shield 60 is a G1 insulation layer 62 that may be made of Al₂O₃. This is followed by a seed stack 64.

In the embodiment shown in FIG. 2, in CIP GMR applications the seed stack 64 includes a lowest layer 66 that may be made of, e.g., AlOₓ that, in a non-limiting embodiment, may have a thickness of thirty Angstroms. For CPP GMR or TMR applications, the seed stack 64 does not include AlOₓ but instead is built on the bottom shield. In any case, in order going up from either the layer 66 or the bottom shield as appropriate for the particular application are a Ni—Fe—Cr sublayer 68 and a Ni—Fe sublayer 70. These sublayers 68, 70 in non-limiting embodiments may have respective thicknesses of thirty two Angstroms and four Angstroms.

In accordance with present principles, in the preferred embodiment of FIG. 2 a layer 72 of Pt—Mn is deposited on the Ni—Fe sublayer 70. In preferred embodiments the thickness of the Pt—Mn layer 72 is five Angstroms, and more generally may be between one and eight Angstroms. Only one Pt—Mn layer need be used in the seed stack.

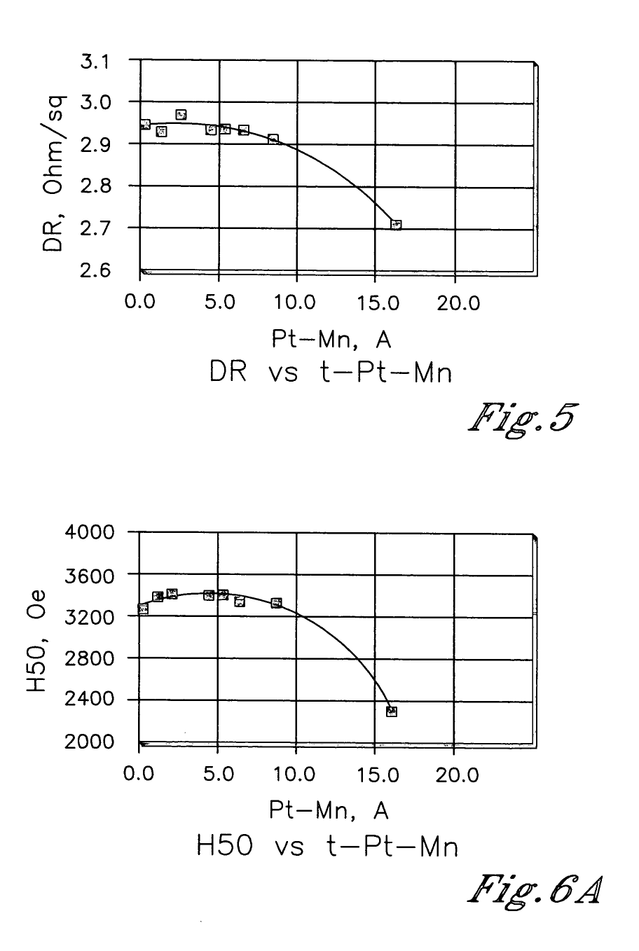

Referring briefly to the alternate embodiment of FIG. 3, as shown instead of disposing the Pt—Mn layer 72 between the Ni—Fe layer 70 and pinning layer 74 as is done in FIG. 2, the Pt—Mn layer 72 in FIG. 3 is disposed just under the Ni—Fe—Cr layer 68. The present invention has found, however, that it is not preferred to interpose the Pt—Mn layer between the Ni—Fe—Cr layer 68 and the Ni—Fe layer 70 due to degradation of spin valve properties.

Following the seed layer 64 deposition, the sequence of layers in the spin valve structure includes an Ir—Mn—Cr antiferromagnetic pinning layer 74 of, e.g., seventy five Angstroms thickness, a pinned stack structure 76 that may be, for example but without limitation, CoFeₓ/Ru/CoFe_{y} or CoFex/Ru/Co—Fe—B, and a layer 78 that may be, for example but without limitation, a Cu or CuOₓ spacer layer in CIP GMR applications, or for example but without limitation a Cu—AlOₓ spacer layer for CPP GMR applications. In TMR applications, AlOₓ may alternatively be used as a barrier layer 78, as can a wide range of other materials including, for example, MgOₓ or TiOₓ.

A free stack structure 80 that may be, for example but without limitation, Co—Fe/Ni—Fe or Co—Fe—B is deposited on the layer 78. The free stack structure 80 may be covered by a protective capping layer of, e.g., Ta or Ru that may in turn may be topped by a gap in case of CIP GMR applications, or an upper magnetic shield in the case of CPP GMR and TMR applications, in accordance with principles known in the art.

Formation of the structures shown in FIGS. 2 and 3 may be undertaken using physical vapor deposition such as sputtering or ion beam deposition, and etching/masking/milling processes known in the art. In preferred non-limiting implementations, the Ir—Mn—Cr pinning layer 74 can be heated after deposition and/or can be deposited onto a heated seed stack, to improve pinning.

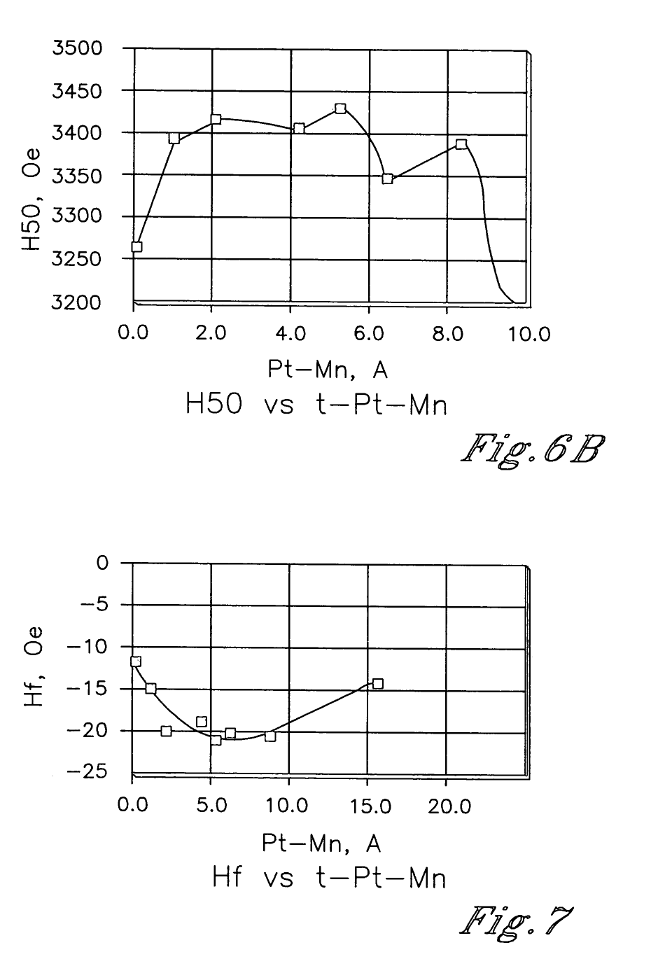

With the above structure and using the preferred five Angstrom thickness of Pt—Mn, the present invention provides for non-degraded GMR, where percent GMR (i.e., the resistance change between the states when the free layer and pinned layer magnetizations are aligned anti-parallel and when they are aligned parallel divided by the structure sheet resistance) is as illustrated in FIG. 4, as well as non-degraded DR (where DR=R times DR/R, R is the structure sheet resistance, and DR/R is the GMR ratio) as shown in FIG. 5.

Most importantly, inserting one to ten Angstroms of Pt—Mn layer 72 between Ni—Fe layer 70 and Ir—Mn—Cr layer 74 improves the pinning fields, as measured by H50, as is shown in FIGS. 6A and 6B. H50 is the applied magnetic field at which the GMR ratio drops by 50%, and serves as a qualitative measure of the strength of pinning of the pinned stack structure. This ten Angstrom Pt—Mn layer 72 also slightly improves blocking temperature between Ir—Mn—Cr and CoFeₓ, as well as advantageously reduces interlayer coupling, Hf, as is shown in FIG. 7. Reduction in interlayer coupling indicates an improved smoothness of the interface between pinned layer 76 and the layer 78, and/or improved smoothness of the interface between the free layer 80 and layer 78. Because of the reduced interlayer coupling attributable to the Pt—Mn layer, the layer 78 may be reduced in thickness, which in turn improves GMR ratio and DR in the case of CIP and CPP GMR applications, or reduces barrier resistance without degrading TMR ratio, the analog of GMR ratio in TMR devices, in the case of TMR applications.

The benefits shown in the above graphs may be attributable to significantly increased Ir—Mn—Cr in-plane grain size, by about forty percent, as determined by X-ray diffraction, and yet with an increased rather than decreased interfacial smoothness, as might be expected when the Ir—Mn—Cr grain size increases. This significantly larger grain size structure is also expected to substantially improve thermal stability of the GMR and TMR spin valve heads due to reduction of grain boundary diffusion.

In other embodiments, the structures shown in FIGS. 2 and 3 may be disposed on a substrate to form part of a magnetic random access memory (MRAM) device.

While the particular SPIN VALVE WITH Ir—Mn—Cr PINNING LAYER AND SEED LAYER INCLUDING Pt—Mn as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

What is claimed is:

1. A magnetoresistive sensor structure, comprising:
a magnetically pinned stack;
a pinning layer including Ir—Mn and magnetically pinning the pinned stack; and
a seed stack comprising a layer of Pt—Mn.

2. The structure of claim 1, wherein the seed stack includes a Ni—Fe—Cr layer covered by a Ni—Fe layer, the layer of Pt—Mn covering the Ni—Fe layer.

3. The structure of claim 1, wherein the seed stack includes the layer of Pt—Mn covered by a Ni—Fe—Cr layer covered by a Ni—Fe layer.

4. The structure of claim 1, wherein the pinning layer is made of Ir—Mn—Cr.

5. The structure of claim 1, wherein the layer of Pt—Mn is between one and ten Angstroms thick.

6. The structure of claim 5, wherein the layer of Pt—Mn is five Angstroms thick.

7. The structure of claim 1, wherein the magnetoresistive sensor structure is incorporated in a magnetoresistive sensor selected from the group consisting of a bottom single or dual current-in-plane or current-perpendicular-to-plane GMR sensor or a bottom single or dual TMR sensor.

8. A method for making a magnetoresistive sensor structure, comprising:
forming a seed stack comprising at least one layer of Pt—Mn; and
depositing onto the seed stack an antiferromagnetic layer comprising Ir—Mn.

9. The method of claim 8, wherein the antiferromagnetic layer is made of Ir—Mn—Cr.

10. The method of claim 8, comprising depositing the antiferromagnetic layer onto a seed layer that is preheated to a temperature sufficient to promote relatively large grain size and/or L1₂ ordering of Ir—Mn—Cr.

11. The method of claim 8, wherein the seed stack includes a Ni—Fe—Cr layer covered by a Ni—Fe layer, the layer of Pt—Mn covering the Ni—Fe layer.

12. The method of claim 8, wherein the seed stack includes the layer of Pt—Mn covered by a Ni—Fe—Cr layer covered by a Ni—Fe layer.

13. The method of claim 8, wherein the layer of Pt—Mn is between one and ten Angstroms thick.

14. The method of claim 13, wherein the layer of Pt—Mn is five Angstroms thick.

15. The method of claim 8, comprising engaging the seed stack with antiferromagnetic layer with a magnetoresistive sensor selected from the group consisting of a bottom single or dual current in plane or current perpendicular to plane GMR sensor or a bottom single or dual TMR sensor.

16. A magnetic recording sensor, comprising:
a free stack;
a pinned stack;
a barrier between the free stack and pinned stack;
an Ir—Mn—Cr layer providing magnetic pinning for the pinned stack; and
a seed stack underlying the Ir—Mn—Cr layer and including means for promoting grain growth and interfacial smoothness in the Ir—Mn—Cr layer.

17. The magnetic recording sensor of claim 16, wherein the means for promoting includes a layer of Pt—Mn.

18. The magnetic recording sensor of claim 17, wherein the seed stack includes a Ni—Fe—Cr layer covered by a Ni—Fe layer, the layer of Pt—Mn covering the Ni—Fe layer.

19. The magnetic recording sensor of claim 17, wherein the seed stack includes the layer of Pt—Mn covered by a Ni—Fe—Cr layer covered by a Ni—Fe layer.

20. The magnetic recording sensor of claim 17, wherein the layer of Pt—Mn is between one and ten Angstroms thick.

21. The magnetic recording sensor of claim 20, wherein the layer of Pt—Mn is five Angstroms thick.

22. The magnetic recording sensor of claim 16, wherein the magnetic recording sensor is incorporated into a magnetic recording head selected from the group consisting of disk drive heads and tape drive heads.

23. A magnetic storage device comprising:
at least one spindle;
at least one magnetic recording disk rotated by the spindle;
a slider juxtaposed with the disk, the slider having at least one magnetic head;
the slider being supported by at least one suspension coupled to an actuator arm rotatably positioned by an actuator, the head including:
a magnetically pinned stack;
a pinning layer including Ir—Mn and magnetically pinning the pinned stack; and
a seed stack comprising a layer of Pt—Mn.

24. The magnetic storage device of claim 23, wherein the seed stack includes a Ni—Fe—Cr layer covered by a Ni—Fe layer, the layer of Pt—Mn covering the Ni—Fe layer.

25. The magnetic storage device of claim 23, wherein the seed stack includes the layer of Pt—Mn covered by a Ni—Fe—Cr layer covered by a Ni—Fe layer.

26. The magnetic storage device of claim 23, wherein the pinning layer is made of Ir—Mn—Cr.

27. The magnetic storage device of claim 23, wherein the layer of Pt—Mn is between one and ten Angstroms thick.

28. The magnetic storage device of claim 27, wherein the layer of Pt—Mn is five Angstroms thick.

29. The magnetic storage device of claim 23, wherein the head is selected from the group consisting of a bottom single or dual current in plane or current perpendicular to plane GMR sensor or a bottom single or dual TMR sensor.

30. A magnetoresistive sensor comprising:
a free stack;
a pinned stack;
a barrier between the free stack and pinned stack;
an Ir—Mn—Cr layer providing magnetic pinning for the pinned stack; and
a seed stack underlying the Ir—Mn—Cr layer and including means for promoting grain growth and interfacial smoothness in the Ir—Mn—Cr layer.

31. The magnetoresistive sensor of claim 30, wherein the means for promoting includes a layer of Pt—Mn.

32. The magnetoresistive sensor of claim 31, wherein the seed stack includes a Ni—Fe—Cr layer covered by a Ni—Fe layer, the layer of Pt—Mn covering the Ni—Fe layer.

33. The magnetoresistive sensor of claim 31, wherein the seed stack includes the layer of Pt—Mn covered by a Ni—Fe—Cr layer covered by a Ni—Fe layer.

34. The magnetoresistive sensor of claim 31, wherein the layer of Pt—Mn is between one and ten Angstroms thick.

35. The magnetoresistive sensor of claim 34, wherein the layer of Pt—Mn is five Angstroms thick.

36. The magnetoresistive sensor of claim 30, wherein the sensor is incorporated into a magnetic recording head selected from the group consisting of disk drive heads and tape drive heads.
